(19) United States
(12) Patent Application Publication
(10) Pub. No.: US 2026/0213639 A1
(43) Pub. Date: Jul. 23, 2026

(54) CHARGE COMPENSATION CIRCUIT FOR IMPROVED RESPONSE TO VOLTAGE BUFFER TRANSIENTS

(71) Applicant: STMicroelectronics International N.V., Geneva (CH)

(72) Inventors: Kallol CHATTERJEE, Kolkata (IN); Vikas Babasaheb BUGADE, Bangalore (IN); Zubair KHAN, Greater Noida (IN); Gautam Dey KANUNGO, Delhi (IN)

(21) Appl. No.: 19/440,263

(22) Filed: Jan. 5, 2026

Related U.S. Application Data
(60) Provisional application No. 63/746,399, filed on Jan. 17, 2025.

(51) Int. Cl. H02M 1/00; H02M 1/088; H02M 3/157; H02M 3/158

(52) U.S. Cl. CPC H02M 1/0038; H02M 1/0009; H02M 1/088; H02M 3/157; H02M 3/158

(57) ABSTRACT

An example circuit having charge compensation circuity for a voltage buffer, a DC-DC converter circuit, and an input-output buffer circuit are provided. The example circuit includes a voltage buffer, a load circuit, and charge compensation circuitry. The voltage buffer receives an input supply at a voltage buffer input port and generates a buffered output at a voltage buffer output port. The load circuit generates a load output current signal, wherein a change in the load output current signal alters a charge at the voltage buffer output port. The charge compensation circuit includes a first charge compensation port and a second charge compensation port electrically connected to the voltage buffer output port. The charge compensation circuit detects the change in the load output current signal based on a triggering signal and compensates the charge at the voltage buffer output port.

### CROSS-REFERENCE TO RELATED APPLICATIONS

This application claims the benefit of U.S. Provisional Patent Application No. 63/746,399, entitled “CHARGE COMPENSATION CIRCUIT FOR IMPROVED RESPONSE TO VOLTAGE BUFFER TRANSIENTS,” which was filed Jan. 17, 2025, the entirety of which is hereby incorporated by reference.

### TECHNOLOGICAL FIELD

Embodiments of the present disclosure relate generally to voltage buffer circuits, and more particularly, to utilizing a charge compensation circuit to improve compensation for voltage buffer transients at a voltage buffer output.

### BACKGROUND

A voltage buffer (e.g., unity gain buffer) is an electronic circuit that provides high input impedance and low output impedance while maintaining the same voltage between the input and output. Voltage buffers may be utilized to isolate different parts of a circuit, for example, preventing a downstream load from affecting a signal source. Voltage buffers are commonly used to drive low-impedance loads, amplify current without altering voltage, and prevent signal degradation. DC-DC converter circuits and input-output buffer circuits commonly use voltage buffers as a stable voltage source.

Applicant has identified many technical challenges and difficulties associated with generating a stable voltage at a voltage buffer in the presence of signal transients. Through applied effort, ingenuity, and innovation, Applicant has solved problems related compensating for signal transients at a voltage buffer by developing solutions embodied in the present disclosure, which are described in detail below.

### BRIEF SUMMARY

Various embodiments are directed to an example circuit comprising charge compensation circuity for a voltage buffer, a DC-DC converter circuit, and an input-output buffer circuit. An example circuit is provided. In some embodiments, the example circuit comprises a voltage buffer, a load circuit, and charge compensation circuitry. The voltage buffer configured to receive an input supply at a voltage buffer input port and generate a buffered output at a voltage buffer output port. The load circuit configured to generate a load output current signal, wherein a change in the load output current signal alters a charge at the voltage buffer output port. The charge compensation circuit, comprising a first charge compensation port and a second charge compensation port electrically connected to the voltage buffer output port. The charge compensation circuit configured to detect the change in the load output current signal based on a triggering signal and compensate the charge at the voltage buffer output port.

In some embodiments, in an instance in which the change in the load output current signal comprises an increase in voltage, the charge compensation circuit removes charge from the voltage buffer output port.

In some embodiments, in an instance in which the change in the load output current signal comprises a decrease in voltage, the charge compensation circuit generates charge at the voltage buffer output port.

In some embodiments, the charge compensation circuit further comprises a charge compensation capacitor.

In some embodiments, a capacitance of the charge compensation capacitor is based on a parasitic capacitance of the load circuit.

In some embodiments, the triggering signal comprises the load output current signal.

In some embodiments, the charge compensation circuit further comprises an inverter electrically connected in series with the charge compensation capacitor.

In some embodiments, the load output current signal comprises an output of a DC-DC converter circuit.

In some embodiments, the triggering signal comprises an input signal to the load circuit.

In some embodiments, the charge compensation circuit further comprises a first compensation transistor and a second compensation transistor.

In some embodiments, a first gate of the first compensation transistor is electrically connected to the triggering signal, and a second gate of the second compensation transistor is electrically connected to an inverse triggering signal.

In some embodiments, the triggering signal comprises an input to an input-output buffer circuit.

An example DC-DC converter circuit is further provided. The example DC-DC converter circuit, comprising a power stage, a voltage buffer, a load circuit, and a charge compensation circuit. The power stage configured to generate an output voltage based on a source voltage and comprising a plurality of stacked transistors, including at least a voltage buffer biased transistor configured to receive a buffered output at a gate terminal. The voltage buffer configured to receive an input supply at a voltage buffer input port and generate the buffered output at a voltage buffer output port. The load circuit configured to generate a load output current signal, wherein a change in the load output current signal alters a charge at the voltage buffer output port. The charge compensation circuit, comprising a first charge compensation port configured to receive the output voltage and a second charge compensation port electrically connected to the voltage buffer output port, wherein the charge compensation circuit detects the change in the output voltage and compensates the charge at the voltage buffer output port.

In some embodiments, in an instance in which the output voltage increases in voltage, the charge compensation circuit removes charge from the voltage buffer output port.

In some embodiments, in an instance in which the output voltage decreases in voltage, the charge compensation circuit generates charge at the voltage buffer output port.

In some embodiments, the charge compensation circuit further comprises a charge compensation capacitor, wherein a capacitance of the charge compensation capacitor is based on a parasitic capacitance of the voltage buffer biased transistor.

An example input-output buffer circuit is also provided. The example input-output buffer circuit, comprising an input port, level-shifter logic circuitry, pre-driver circuitry, a driver stage, a voltage buffer, and a charge compensation circuit. The input port configured to receive an input signal. The level-shifter logic circuitry configured to generate a first level-shifted output signal and a second level-shifted output signal. The pre-driver circuitry comprising a high pre-driver stage and a low pre-driver stage. The high pre-driver stage configured to receive the first level-shifted output signal and generate a high pre-driver signal based on a voltage supply and a low reference voltage. The low pre-driver stage configured to receive the second level-shifted output signal and generate a low pre-driver signal. The driver stage configured to generate a voltage-adjusted output signal based on the high pre-driver signal, and the low pre-driver signal. The voltage buffer configured to receive an input supply at a voltage buffer input port and generate the low reference voltage at a voltage buffer output port. The charge compensation circuit comprising a first charge compensation port configured to receive the input signal and a second charge compensation port electrically connected to the voltage buffer output port, wherein the charge compensation circuit compensates a charge at the voltage buffer output port based on the input signal.

In some embodiments, in an instance in which the input signal increases in voltage, the charge compensation circuit generates charge at the voltage buffer output port.

In some embodiments, in an instance in which the input signal decreases in voltage, the charge compensation circuit removes charge from the voltage buffer output port.

In some embodiments, the charge compensation circuit further comprises a charge compensation capacitor, wherein a capacitance of the charge compensation capacitor is based on a parasitic capacitance of a transistor of the high pre-driver stage.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example voltage buffer connected to load circuit in accordance with an example embodiment of the present disclosure.

FIG. 2A-FIG. 2B illustrate an example voltage buffer at an example power stage of an electronic circuit in accordance with an example embodiment of the present disclosure.

FIG. 3A-FIG. 3B illustrate an example voltage buffer at an input-output buffer circuit in accordance with an example embodiment of the present disclosure.

FIG. 4 depicts an example charge compensation circuit at a voltage buffer output in accordance with an example embodiment of the present disclosure.

FIG. 5 illustrates an example power stage of a DC-DC converter circuit comprising a charge compensation circuit in accordance with an example embodiment of the present disclosure.

FIG. 6A-FIG. 6B illustrates an example input-output buffer circuit comprising a charge compensation circuit in accordance with an example embodiment of the present disclosure.

FIG. 7 illustrates a graph of buffered output at a voltage buffer attached to a charge compensation circuit in accordance with an example embodiment of the present disclosure.

FIG. 8 illustrates an example graph of a voltage-adjusted output signal from an input-output buffer circuit in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments of the present disclosure address technical problems associated with compensating for signal transients at the output of a voltage buffer circuit. As understood by those of skill in the field to which the present disclosure pertains, there are numerous example circuits which may benefit from improved compensation for signal transients at the output a voltage buffer circuit, particularly in low power applications.

For example, a voltage buffer, also known as a unity gain buffer, is an electronic circuit that provides high input impedance and low output impedance while maintaining the same voltage between the input and output of the voltage buffer. Voltage buffers may be utilized to isolate different parts of a circuit, for example, preventing a downstream load from affecting a signal source. Voltage buffers are commonly used to drive low-impedance loads, amplify current without altering voltage, and prevent signal degradation. DC-DC converter circuits and input-output buffer circuits commonly use voltage buffers as a stable voltage source.

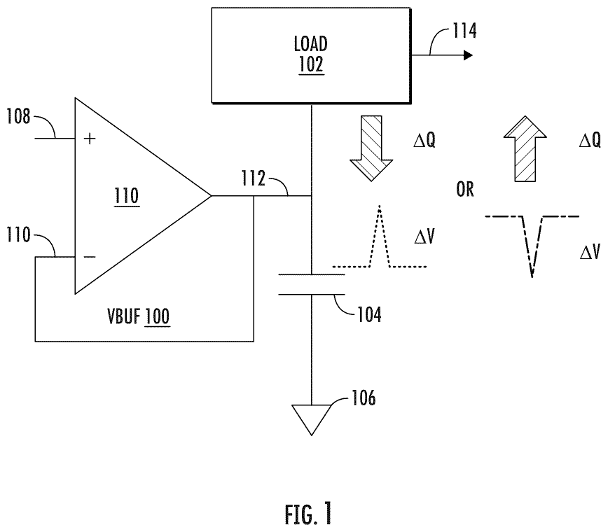

Referring now to FIG. 1, an example voltage buffer 100 is depicted. As depicted in FIG. 1, the voltage buffer 100 includes an operational amplifier 110 comprising a non-inverting input port (+), an inverting input port (−), and an output port. The operational amplifier 110 receives a reference voltage 108 at the non-inverting input port (+) and is configured to generate a buffered output 112. In addition, a conductive feedback path connects the output port of the operational amplifier 110 to the inverting input port (−).

As depicted in FIG. 1, the difference between the reference voltage 108 received at the non-inverting input port (+) and the buffered output 112 received at the inverting input port (−) is amplified. The conductive feedback path forces the operational amplifier 110 to adjust its output voltage (e.g., buffered output 112) until it matches the input voltage (e.g., reference voltage 108). The buffered output 112 experiences unity voltage gain compared to the reference voltage 108, however the buffered output 112 may experience gains in current.

As further depicted in FIG. 1, the output port of the operational amplifier 110 is electrically connected to a capacitor 104 which is further electrically connected to an electrical ground 106. The output port of the operational amplifier 110 is further electrically connected to a load circuit 102. As further depicted in FIG. 1, the load circuit 102 is configured to generate a load output current signal 114.

The load circuit 102 and corresponding load output current signal 114 may have an effect on the buffered output 112 at the output port of the voltage buffer 100. For example, a sudden increase or decrease in the load output current signal 114 may cause signal transients at the output of the voltage buffer 100. A signal transient refers to a temporary, rapid change in voltage at the output of a voltage buffer 100. A signal transient may refer to a voltage spike or a voltage dip at the output port of the voltage buffer 100.

As depicted in FIG. 1, a voltage spike is caused by charges pushed to the output port and the inverting port (−) of the of the operational amplifier 110. The increase in charge causes the operational amplifier 110 to adjust the buffered output 112 until the buffered output 112 once again stabilizes at the reference voltage 108.

As further depicted in FIG. 1, a voltage dip is caused by charges pulled away from the output port and the inverting port (−) of the of the operational amplifier 110. The decrease in charge causes the operational amplifier 110 to adjust the buffered output 112 until the buffered output 112 stabilizes at the reference voltage 108.

Depending on the application and parameters of the voltage buffer 100 and associated circuitry, the time to resettle the buffered output 112 in response to a sudden change in charge at the buffered output 112, may be too long. One way to reduce the settling time due to sudden changes in charge at the buffered output 112 is to increase the output capacitance. However, increasing the output capacitance may require significant area and cost. Increasing the output capacitance may be disfavored, particularly in applications with strict size and/or cost requirements. Another way to reduce the settling time of the buffered output 112 due to sudden changes in charge at the output of the voltage buffer 100 may be to increase the bandwidth of the voltage buffer 100. However, increasing the voltage buffer's bandwidth requires more power, and may similarly be disfavored, particularly in applications with strict power requirements.

The various example embodiments described herein utilize various techniques to reduce the settling time of the buffered output of a voltage buffer in the presence of sudden changes to a load output current signal (e.g., signal transients). For example, in some embodiments, a charge compensation circuit may be provided. The charge compensation circuit may detect a change in the load output based on a triggering signal. A triggering signal may be an input or output to the load circuit indicating a sudden change in the load output current signal. In some embodiments, the load output current signal and the triggering signal may be the same signal.

The charge compensation circuit may compensate the charge at the voltage buffer output port to counteract the change in charge from the change in the load output current signal. For example, in an instance in which the load output current signal causes an increase in charge at the buffered output of the voltage buffer, the charge compensation circuit may pull additional charge from the buffered output. Further, in an instance in which the load output current signal causes a decrease in charge at the buffered output of the voltage buffer, the charge compensation circuit may push additional charge to the buffered output. In this way, the charge compensation circuit counteracts the effect of signal transients and reduces the settling time of the buffered output of the voltage buffer.

As a result of the herein described example embodiments, the effectiveness and efficiency of a voltage buffer may be greatly improved, particularly in relation to low power and/or low space requirements. In addition, operation of various circuits utilizing the voltage buffer may further be greatly improved.

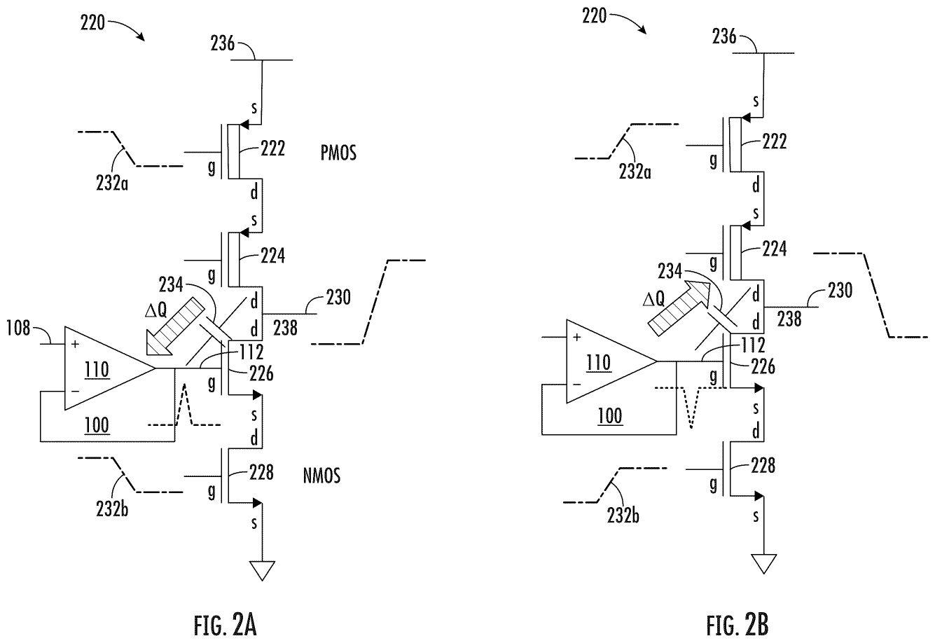

Referring now to FIG. 2A and FIG. 2B, an example power stage 220 of a DC-DC converter circuit is provided. A DC-DC converter circuit is an electronic circuit that converts one voltage level of a direct current signal (e.g., DC-DC input signal, not shown) to another voltage level (e.g., output voltage 230). In this way, for example, the output voltage 230 may replicate the DC-DC input signal but at a higher voltage level. A DC-DC converter circuit is commonly used to step up (boost) a DC-DC input signal, step down (buck) a DC-DC input signal or regulate the voltage of a DC-DC input signal to meet the requirements of a specific application. In many applications, it is critical that a DC-DC converter circuit provides efficient power conversion and a stable voltage supply (e.g., output voltage 230).

The power stage 220 of a DC-DC converter circuit is provided in FIG. 2A and FIG. 2B. As depicted in FIG. 2A and FIG. 2B, the power stage 220 of the DC-DC converter circuit utilizes stacked transistors (e.g., transistor 222, 224, 226, 228) to translate an input signal 232a, 232b into an output voltage 230 based on a high supply voltage 236. The input signal 232a, 232b is an electric signal generated internally by the DC-DC converter circuit.

As depicted in FIG. 2A and FIG. 2B, the first stack of transistors between the high supply voltage 236 and the output voltage 230 are PMOS transistors 222, 224 electrically connected in series. Specifically, the first PMOS transistor 222 comprises a source terminal 222s, a gate terminal 222g, and a drain terminal 222d. The source terminal 222s of the first PMOS transistor 222 is electrically connected to the high supply voltage 236, and the gate terminal 222g is electrically connected to the input signal 232a.

The second PMOS transistor 224 comprises a source terminal 224s, a gate terminal 224g, and a drain terminal 224d. The source terminal 224s of the second PMOS transistor 224 is electrically connected to the drain terminal 222d of the first PMOS transistor 222. The drain terminal 224d of the second PMOS transistor 224 is electrically connected to the net point 238 and is configured to provide the output voltage 230.

As further depicted in FIG. 2A and FIG. 2B, the second stack of transistors between the high supply voltage 236 and the output voltage 230 are NMOS transistors 226, 228 electrically connected in series. Specifically, the first NMOS transistor 226 (e.g., voltage buffer biased transistor) comprises a source terminal 226s, a gate terminal 226g, and a drain terminal 226d. The drain terminal 226d of the first NMOS transistor 226 is electrically connected to the net point 238.

The second NMOS transistor 228 comprises a source terminal 228s, a gate terminal 228g, and a drain terminal 228d. The source terminal 228s of the second NMOS transistor 228 is electrically connected to an electrical ground. The drain terminal 228d of the second NMOS transistor 228 is electrically connected to the source terminal 226s of the first NMOS transistor 226. The gate terminal 228g of the second NMOS transistor 228 is electrically connected to the to the input signal 232b.

As further depicted in FIG. 2A and FIG. 2B, the gate terminal 226g of the first NMOS transistor 226 is electrically connected to a buffered output 112 of a voltage buffer 100. As depicted in FIG. 2A and FIG. 2B, the voltage buffer 100 is configured to receive a reference voltage 108 at the non-inverting input of the operational amplifier 110 included in the voltage buffer 100. Although not depicted in FIG. 2A and FIG. 2B, during operation, the gate terminal 224g of the second PMOS transistor 224 is electrically connected to a buffered output of a voltage buffer (not shown in FIG. 2A and FIG. 2B).

The voltage buffer at the power stage 220 of the DC-DC converter circuit provides a stable intermediate voltage (e.g., buffered output 112) to the gate terminal of the transistor 226. In some embodiments, the stable intermediate voltage prevents the transistors 226, 228 from being exposed to voltages in violation of the voltage rating of the transistors 226, 228. A voltage rating of a transistor is a maximum voltage difference that may occur across any two terminals of the transistor. A voltage difference across any two terminals of a transistor exceeding the maximum voltage rating of the transistor may cause damage to the transistor. Transistors exposed to voltages in excess of the maximum voltage rating of the transistor may degrade in performance and/or fail. The stacked transistors 226, 228 and voltage buffers (e.g., voltage buffer 100) may prevent any one transistor 226, 228 in the power stage 220 of the DC-DC converter circuit from being exposed to voltage differences in excess of a maximum voltage rating of the transistors. A similar voltage buffer may be positioned at the gate of transistor 224 to protect transistor 222 and transistor 224, however the similar voltage buffer is not shown in FIG. 2A and FIG. 2B to avoid clutter.

As further depicted in FIG. 2A and FIG. 2B, each transistor 222, 224, 226, 228 comprises a parasitic capacitance 234. A parasitic capacitance 234 is any stray capacitance of an electrical component (e.g., transistor 222, 224, 226, 228) inherent due to the structure of the electrical component and/or proximity of other electrical components. The parasitic capacitance 234 represents the stray capacitance between the gate terminal 226g and the drain terminal 226d of the first NMOS transistor 226.

FIG. 2A depicts a transition at the power stage 220 of the DC-DC converter circuit from a low to a high output voltage 230 (e.g., high supply voltage 236). The transition from a low to a high output voltage 230 is caused by a transition of the input signal 232a, 232b from high to low, disabling the second NMOS transistor 228 and enabling the first PMOS transistor 222. The transition of the input signal 232a, 232b is caused by the internal circuitry of the DC-DC converter circuit (not shown).

As depicted in FIG. 2A, the sudden rise in the output voltage 230 causes additional charge (ΔQ) to be pushed to the output terminal of the operational amplifier 110 of the voltage buffer 100. The additional charge causes a voltage spike in the buffered output 112. The time required to resettle the buffered output 112 after a voltage spike may have adverse effects on the DC-DC converter circuit and any electrical devices utilizing the DC-DC converter circuit. The settling time of the buffered output 112 may be particularly problematic in instances in which the reference voltage 108 is a low voltage signal.

FIG. 2B depicts a transition at the power stage 220 of the DC-DC converter circuit from a high to a low output voltage 230 (e.g., electrical ground). The transition from a high to a low output voltage 230 is caused by a transition of the input signal 232a, 232b from low to high, enabling the second NMOS transistor 228 and disabling the first PMOS transistor 222. The transition of the input signal 232a, 232b is caused by the internal circuitry of the DC-DC converter circuit (not shown).

As depicted in FIG. 2B, the sudden drop in the output voltage 230 causes charge (ΔQ) to be pulled from the output terminal of the operational amplifier 110 of the voltage buffer 100. The reduced charge causes a voltage dip in the buffered output 112. The time required to resettle the buffered output 112 after a voltage dip may have adverse effects on the DC-DC converter circuit and any electrical devices utilizing the DC-DC converter circuit. The settling time of the buffered output 112 may be particularly problematic in instances in which the reference voltage 108 is a low voltage signal.

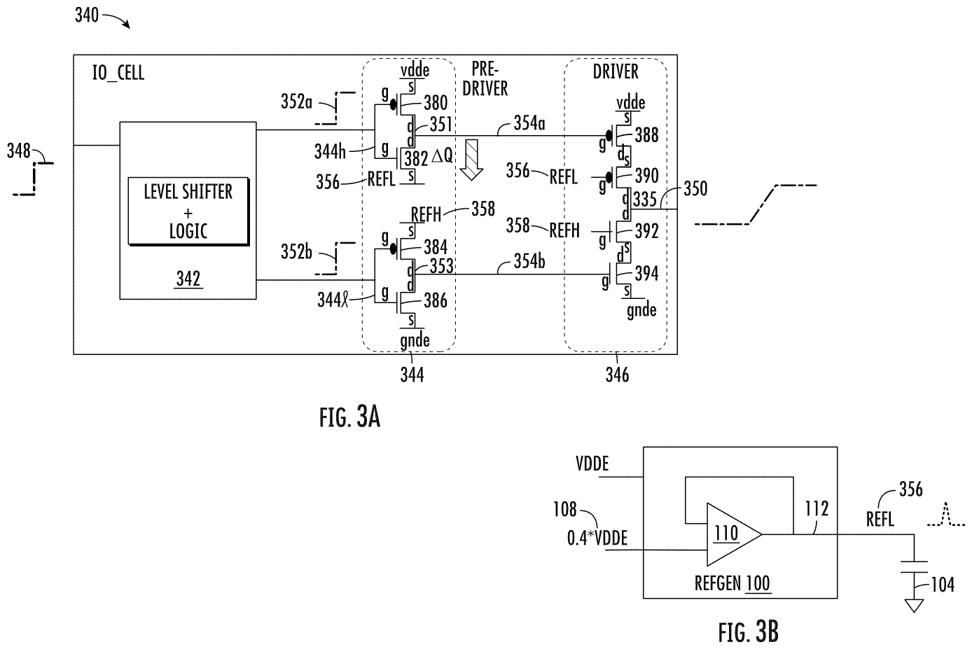

Referring now to FIG. 3A an example input-output buffer circuit 340 is provided. An input-output buffer circuit 340 provides a buffer between a peripheral intellectual property (IP) circuit (e.g., first domain) and a main electrical system (e.g., a system-on-chip, second domain), or vice versa. An input-output buffer circuit 340 ensures an output signal (e.g., voltage-adjusted output signal 350) is generated based on an input signal 348 such that proper signal amplification and impedance matching are provided to ensure accurate data transmission between the first domain and the second domain. The input-output buffer circuit 340 is configured to generate the voltage-adjusted output signal 350 based on the input signal 348 with minimal delay. Delays in the generation of the voltage-adjusted output signal 350 may decrease the performance of the electrical system utilizing the input-output buffer circuit 340.

As depicted in FIG. 3A, the input-output buffer circuit 340 includes level-shifter and logic circuitry 342 configured to generate a first level-shifted output signal 352a and a second level-shifted output signal 352b based on the input signal 348 received at an input port of the input-output buffer circuit 340.

As further depicted in FIG. 3A, the input-output buffer circuit 340 includes pre-driver circuitry 344 configured to generate a high pre-driver signal 354a based on the first level-shifted output signal 352a and a low pre-driver signal 354b based on the second level-shifted output signal 352b.

As further depicted in FIG. 3A, the input-output buffer circuit 340 includes a driver stage 346 configured to generate the voltage-adjusted output signal 350 based on the high pre-driver signal 354a and the low pre-driver signal 354b.

As depicted in FIG. 3A, the pre-driver circuitry 344 includes a high pre-driver stage 344h and a low pre-driver stage 344l. The high pre-driver stage 344h includes a PMOS transistor 380 (comprising a source terminal 380s, a gate terminal 380g, and a drain terminal 380d) electrically connected in series with an NMOS transistor 382 (comprising a source terminal 382s, a gate terminal 382g, and a drain terminal 382d). Specifically, the source terminal 380s of the PMOS transistor 380 is electrically connected to a supply voltage (vdde). The gate terminal 380g of the PMOS transistor 380 is configured to receive the first level-shifted output signal 352a. The drain terminal 380d of the PMOS transistor 380 is electrically connected to the net point 351 and the drain terminal 382d of the NMOS transistor 382.

As further depicted in FIG. 3A, the drain terminal 382d of the NMOS transistor 382 is electrically connected to the net point 351 and the drain terminal 380d of the PMOS transistor 380. The gate terminal 382g of the NMOS transistor 382 is configured to configured to receive the first level-shifted output signal 352a. The source terminal 382s of the NMOS transistor 382 is configured to receive a low reference voltage 356. The low reference voltage 356 may be generated by a voltage reference generator circuit, for example, the voltage reference generator circuit described in relation to FIG. 3B. The low reference voltage 356 provides an intermediate reference voltage between the supply voltage (vdde) and electrical ground (gnde). The low reference voltage 356 may be based on a percentage and/or voltage-divided output of the supply voltage (vdde).

As seen from the high pre-driver stage 344h of FIG. 3A, the high pre-driver signal 354a is based on an inversion of the first level-shifted output signal 352a. However, the high pre-driver signal 354a is confined to voltages between the supply voltage (vdde) and the low reference voltage 356. Thus, the high pre-driver signal 354a does not vary across the full range between the supply voltage (vdde) and electrical ground (gnde).

As further depicted in FIG. 3A, the pre-driver circuitry 344 includes a low pre-driver stage 344l. The low pre-driver stage 344l includes a PMOS transistor 384 (comprising a source terminal 384s, a gate terminal 384g, and a drain terminal 384d) electrically connected in series with an NMOS transistor 386 (comprising a source terminal 386s, a gate terminal 386g, and a drain terminal 386d). Specifically, the source terminal 384s of the PMOS transistor 384 is electrically connected to a high reference voltage 358. The high reference voltage 358 may be generated by a voltage reference generator circuit, for example, the voltage reference generator circuit described in relation to FIG. 3B. The high reference voltage 358 provides an intermediate reference voltage between the supply voltage (vdde) and electrical ground (gnde). The high reference voltage 358 may be based on a percentage and/or voltage-divided output of the supply voltage (vdde).

The gate terminal 384g of the PMOS transistor 384 is configured to receive the second level-shifted output signal 352b. The drain terminal 384d of the PMOS transistor 380 is electrically connected to the net point 353 and the drain terminal 386d of the NMOS transistor 386.

As further depicted in FIG. 3A, the drain terminal 386d of the NMOS transistor 386 is electrically connected to the net point 353 and the drain terminal 384d of the PMOS transistor 384. The gate terminal 386g of the NMOS transistor 386 is configured to configured to receive the second level-shifted output signal 352b. The source terminal 386s of the NMOS transistor 386 is electrically connected to electrical ground (gnde).

As seen from the low pre-driver stage 344l of FIG. 3A, the low pre-driver signal 354b is based on an inversion of the second level-shifted output signal 352b. However, the low pre-driver signal 354b is confined to voltages between the high reference voltage 358 and electrical ground (gnde). Thus, the low pre-driver signal 354b does not vary across the full range between the supply voltage (vdde) and electrical ground (gnde).

As depicted in FIG. 3A, the high pre-driver signal 354a represents an inversion of the first level-shifted output signal 352a confined to the voltage range between the supply voltage (vdde) and the low reference voltage 356. The low pre-driver signal 354b represents an inversion of the second level-shifted output signal 352b confined to the voltage range between the high reference voltage 358 and electrical ground (gnde).

As further depicted in FIG. 3A, the input-output buffer circuit 340 includes driver stage 346. The driver stage 346 comprises a plurality of transistors (e.g., transistors 388, 390, 392, 394) in a stacked configuration. The driver stage 346 is configured to receive the high pre-driver signal 354a and the low pre-driver signal 354b and generate the voltage-adjusted output signal 350.

Specifically, the driver stage 346 comprises a first PMOS transistor 388 comprising a source terminal 388s, a gate terminal 388g, and a drain terminal 388d; a second PMOS transistor 390 comprising a source terminal 390s, a gate terminal 390g, and a drain terminal 390d; a first NMOS transistor 392 comprising a source terminal 392s, a gate terminal 392g, and a drain terminal 392d; and a second NMOS transistor 394 comprising a source terminal 394s, a gate terminal 394g, and a drain terminal 394d.

The source terminal 388s of the first PMOS transistor 388 is electrically connected to the supply voltage (vdde). The gate terminal 388g is configured to receive the high pre-driver signal 354a. The drain terminal 388d is electrically connected to the source terminal 390s of the second PMOS transistor 390.

The gate terminal 390g of the second PMOS transistor 390 is configured to receive the low reference voltage 356. The drain terminal 388d is electrically connected to the net point 355. The net point 355 is configured to provide the voltage-adjusted output signal 350.

As further depicted in FIG. 3A, the drain terminal 392d of the first NMOS transistor 392 is electrically connected to the net point 355, the gate terminal 392g is configured to receive the high reference voltage 358, and the source terminal 392s is electrically connected to the drain terminal 394d of the second NMOS transistor 394.

The gate terminal 394g of the second NMOS transistor 394 is configured to receive the low pre-driver signal 354b. The source terminal 394s is electrically connected to electrical ground (gnde).

Referring now to FIG. 3B, an example voltage reference generator circuit comprising at least a voltage buffer 100, is provided. Although only the voltage buffer 100 configured to generate the low reference voltage 356 is depicted in FIG. 3B, the high reference voltage 358 may be generated by a similar voltage buffer with a different input reference voltage. As depicted in FIG. 3B, the voltage buffer 100 is configured to receive a reference voltage 108 based on the supply voltage (vdde) to the input-output buffer circuit 340. For example, the reference voltage 108 may be a voltage divided value of the supply voltage (vdde). The generated low reference voltage 356 is transmitted to various components of the input-output buffer circuit 340 as a stable voltage source.

As depicted in FIG. 3A, the low reference voltage 356 is provided at the source terminal 382s of the NMOS transistor 382 in the high pre-driver stage 344h of the input-output buffer circuit 340. FIG. 3A further depicts the transition of the input signal 348 from a low voltage state to a high voltage state. In response to the input signal 348 transitioning from a low voltage state to a high voltage state, the first level-shifted output signal 352a also transitions from a low voltage state to a high voltage state, and the high pre-driver signal 354a transitions from a high voltage state (e.g., equal to supply voltage (vdde)) to a low voltage state (e.g., equal to low reference voltage 356). The transition from the supply voltage (vdde) to the low reference voltage 356 at net point 351 causes a spike in charge (that translates to a voltage spike) at the output of the voltage buffer generating the low reference voltage 356 (e.g., the voltage buffer 100 as depicted in FIG. 3B). The influx of charge causes operational amplifier 110 to adjust until the buffered output 112 is once again at the reference voltage 108. However, the time required to resettle the buffered output 112 causes a delay in the transition of the voltage-adjusted output signal 350 from a low voltage state to a high voltage state. Such a delay may have a negative impact on the responsiveness and performance of the electrical system utilizing the input-output buffer circuit 340.

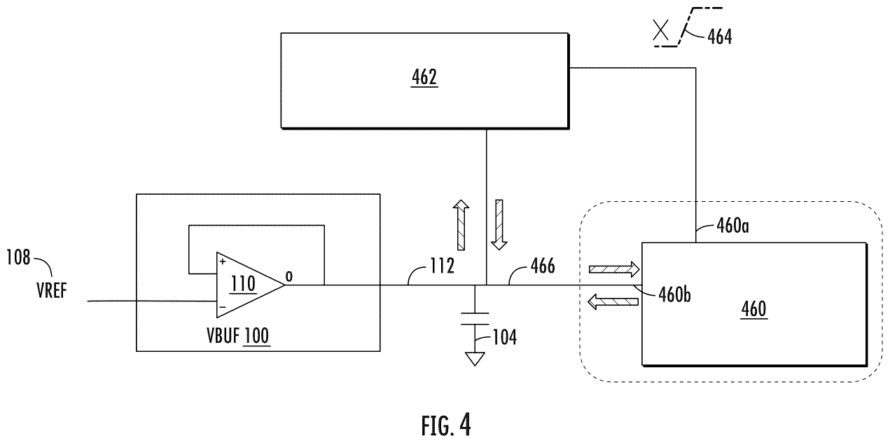

Referring now to FIG. 4, an example charge compensation circuit 460 comprising a first port 460a and a second port 460b is provided. A charge compensation circuit 460 comprises any circuitry including hardware and/or software configured to determine a change in charge (e.g., voltage) at an output (e.g., buffered output 112) of a voltage buffer 100 and adjust the charge at the output of the voltage buffer 100 to compensate for the change in charge. Adjusting the charge at the output of the voltage buffer 100 enables the voltage buffer 100 to resettle more quickly in the presence of a signal transient.

As depicted in FIG. 4, the voltage buffer 100 comprises an operational amplifier 110 configured to receive a reference voltage 108 (e.g., input supply) at a non-inverting input port (+) (e.g., voltage buffer input port) and generate a buffered output 112 at an output port 110o. The buffered output 112 at the output port 110o of the operational amplifier 110 are further electrically connected back to the inverting port (−) of the operational amplifier 110. The output port 110o is electrically connected to net point 466 of the depicted circuit.

As further depicted in FIG. 4, a load circuit 462 is electrically connected to the net point 466 and the output port 110o of the operational amplifier 110. The load circuit 462 is configured to receive the buffered output 112. The net point 466 is further electrically connected to electrical ground through a capacitor 104.

As further depicted in FIG. 4, the second port 460b of the charge compensation circuit 460 is electrically connected to the net point 466 and thus the output port 110o of the operational amplifier 110 and is further configured to receive the buffered output 112. In addition, the first port 460a of the charge compensation circuit 460 is electrically connected to a triggering signal 464 associated with the load circuit 462.

The triggering signal 464 is any electrical signal generated or received by the load circuit 462 that indicates a change in charge at the net point 466 associated with the buffered output 112 of the voltage buffer 100. As described in relation to FIG. 1, in some embodiments, the load circuit 462 may generate a load output current signal (e.g., load output current signal 114) that causes a sudden change in charge at the output of a voltage buffer.

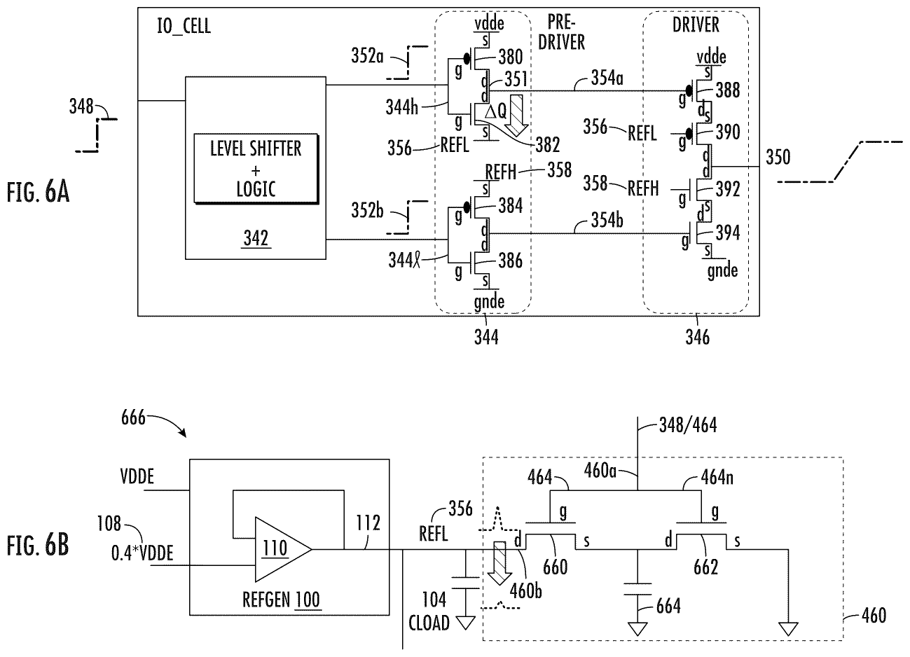

In some embodiments, the triggering signal 464 may be received by the load circuit 462 and indicate the voltage buffer 100 is going to see a charge gain or loss. An example triggering signal 464 as an input to the load circuit 462 is described in relation to FIG. 6A to FIG. 6B.

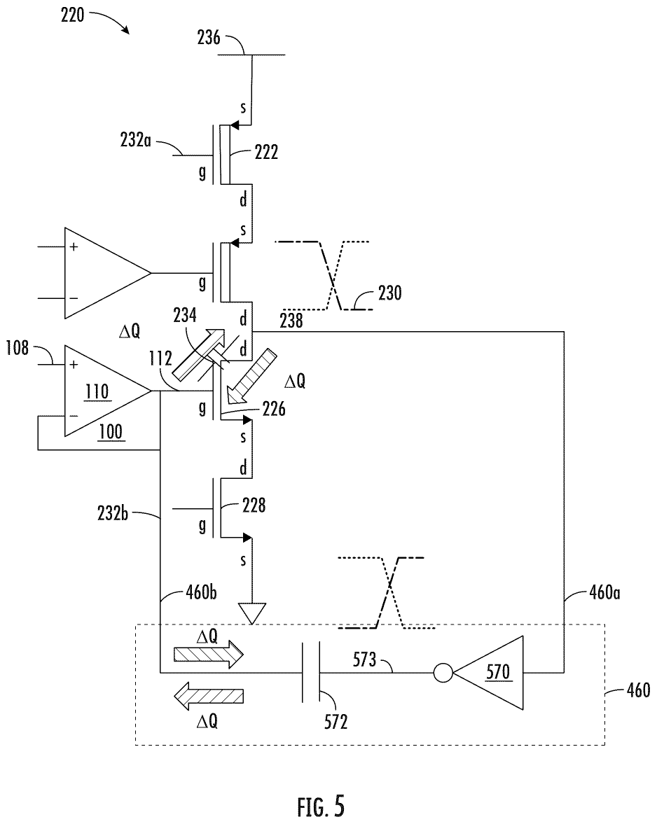

Referring now to FIG. 5, an example charge compensation circuit 460 at the power stage 220 of an example DC-DC converter circuit is provided.

Specifically, the first PMOS transistor 222 comprises a source terminal 222s, a gate terminal 222g, and a drain terminal 222d. The source terminal 222s of the first PMOS transistor 222 is electrically connected to the high supply voltage 236, and the gate terminal 222g is electrically connected to the input signal 232a.

As depicted in FIG. 5, the source terminal 222s of the first PMOS transistor 222 is electrically connected to a high supply voltage 236, and the gate terminal 222g is electrically connected to an input signal 232a (e.g., source voltage) based on the input signal to the DC-DC converter circuit (not shown). The source terminal 224s of the second PMOS transistor 224 is electrically connected to the drain terminal 222d of the first PMOS transistor 222. The drain terminal 224d of the second PMOS transistor 224 is electrically connected to the net point 238 and is configured to provide the output voltage 230.

As further depicted in FIG. 5, the drain terminal 226d of the first NMOS transistor 226 is electrically connected to the net point 238. The drain terminal 228d of the second NMOS transistor 228 is electrically connected to the source terminal 226s of the first NMOS transistor 226. The source terminal 228s of the second NMOS transistor 228 is electrically connected to an electrical ground. The gate terminal 228g of the second NMOS transistor 228 is electrically connected to the to the input signal 232b (e.g., source voltage).

As further depicted in FIG. 5, the gate terminal 226g of the first NMOS transistor 226 is electrically connected to a buffered output 112 of a voltage buffer 100. The voltage buffer 100 is configured to receive a reference voltage 108 at the non-inverting input of the operational amplifier 110 included in the voltage buffer 100. As further depicted in FIG. 5, the gate terminal 224g of the second PMOS transistor 224 is electrically connected to a second buffered output of a second voltage buffer.

An example embodiment of a charge compensation circuit 460 is further depicted in FIG. 5. The charge compensation circuit 460 includes a first charge compensation port 460a and a second charge compensation port 460b. The first charge compensation port 460a is electrically connected to the net point 238 and configured to receive the output voltage 230 (e.g., triggering signal). The second charge compensation port 460b is electrically connected to the output port of the voltage buffer 100.

The charge compensation circuit 460 includes an inverter 570 and a charge compensation capacitor 572. The inverter 570 generates an inverted output voltage 573 based on the output voltage 230. The output of the inverter 570 is electrically connected to a first terminal of the charge compensation capacitor 572. The second terminal of the charge compensation capacitor 572 is electrically connected to the second charge compensation port 460b and the output of the voltage buffer 100.

As depicted in FIG. 5, in an instance in which the output voltage 230 decreases, the inverted output voltage 573 increases. The increase in voltage at the first terminal of the charge compensation capacitor 572 (e.g., inverted output voltage 573) pushes additional charge toward the output of the voltage buffer 100. The additional charge at the output of the voltage buffer 100 compensates for the charge pulled away from the output of the voltage buffer 100 by the sudden decrease in the output voltage 230.

Conversely, in an instance in which the output voltage 230 increases, the inverted output voltage 573 decreases. The decrease in voltage at the first terminal of the charge compensation capacitor 572 (e.g., inverted output voltage 573) pulls charge from the output of the voltage buffer 100. The reduction in charge at the output of the voltage buffer 100 due to the charge compensation circuit 460 compensates for the additional charge pushed toward the output of the voltage buffer 100 by the sudden increase in the output voltage 230.

The charge compensation capacitor 572 in the charge compensation circuit 460 comprises any capacitive device configured to generate a potential difference between two conductors (e.g., terminals) separated by a dielectric. In some embodiments, in an instance in which a positive electric charge is at one terminal and equal and opposite electric charge is at another terminal. The gathering of positive or negative electric charge at the second terminal of the charge compensation capacitor 572 may change the electrical properties of the output of the voltage buffer 100. For example, gathering negative electric charge at the second terminal of the charge compensation capacitor 572 may cause a net increase in charge at the output of the voltage buffer 100. Conversely, gathering positive electric charge at the second terminal of the charge compensation capacitor 572 may cause a net decrease in charge at the output of the voltage buffer 100.

As described in relation to FIG. 2A-FIG. 2B, the parasitic capacitance 234 represents the stray capacitance between the gate terminal 226g and the drain terminal 226d of the first NMOS transistor 226. In some embodiments, the capacitance of the charge compensation capacitor 572 may be configured to match the parasitic capacitance 234. In an instance in which the capacitance of the charge compensation capacitor 572 matches the parasitic capacitance 234 the change in charge at the output 112 of the voltage buffer 100 due to the change in the output voltage 230 may be matched with an equal and opposite change in charge from the charge compensation capacitor 572 by a change in the inverted output voltage 573.

Referring now to FIG. 6A and FIG. 6B, an example embodiment of a charge compensation circuit 460 in an example input-output buffer circuit 340 is provided.

The input-output buffer circuit 340 of FIG. 3A is replicated in FIG. 6A. As depicted in FIG. 6A, a low reference voltage 356 is provided at various components of the input-output buffer circuit 340. As depicted in FIG. 6A, the low reference voltage 356 is provided at the source terminal 382s of the NMOS transistor 382 in the high pre-driver stage 344h of the input-output buffer circuit 340. FIG. 6A further depicts the transition of the input signal 348 from a low voltage state to a high voltage state. In response to the input signal 348 transitioning from a low voltage state to a high voltage state, the first level-shifted output signal 352a also transitions from a low voltage state to a high voltage state, and the high pre-driver output 354a transitions from a high voltage state (e.g., equal to supply voltage (vdde)) to a low voltage state (e.g., equal to low reference voltage 356). The transition from the supply voltage (vdde) to the low reference voltage 356 at net point 351 causes a spike in charge (e.g., voltage spike) at the source terminal 382s of the NMOS transistor 382. Thus, a spike in charge is observed at the output terminal of the voltage buffer (e.g., voltage buffer 100 depicted in FIG. 6B) generating the low reference voltage 356.

Referring now to FIG. 6B, an example voltage reference generator circuit 666 comprising at least a voltage buffer 100 electrically connected to an example charge compensation circuit 460 is provided. As depicted in FIG. 6B, the voltage buffer 100 is configured to receive a reference voltage 108. The high reference voltage 358 may be generated by a similar voltage buffer with a different input reference voltage and is not shown here.

The example charge compensation circuit 460 compensates the influx of charge at the buffered output 112 of the voltage buffer 100 based on the input signal 348 (e.g., triggering signal 464). As depicted in FIG. 6A, the transition of the input signal 348 from a low voltage state to a high voltage state may precede the transition of the high pre-driver signal 354a from a high voltage state (vdde) to a low voltage state (low reference voltage 356). Thus, the charge compensation circuit 460 may utilize the input signal 348 as the triggering signal 464 and compensate the charge at the output of the voltage buffer 100 accordingly.

As depicted in FIG. 6B, the charge compensation circuit 460 is configured to receive the input signal 348 at a first charge compensation port 460a. The charge compensation circuit 460 comprises a first compensation transistor 660, a second compensation transistor 662, and a charge compensation capacitor 664. The first compensation transistor 660 comprises a source terminal 660s, a gate terminal 660g, and a drain terminal 660d. The second compensation transistor 662 comprises a source terminal 662s, a gate terminal 662g, and a drain terminal 662d.

The gate terminal 660g of the first compensation transistor 660 is configured to receive the triggering signal 464 while the gate terminal 662g of the second compensation transistor 662 is configured to receive the inverse triggering signal 464n. The source terminal 662s of the second compensation transistor 662 is electrically connected to electrical ground. The drain terminal 662d of the second compensation transistor 662 is electrically connected to a first terminal of the charge compensation capacitor 664. The second terminal of the charge compensation capacitor 664 is electrically connected to electrical ground.

The source terminal 660s of the first compensation transistor 660 is further electrically connected to the first terminal of the charge compensation capacitor 664. The drain terminal 660d of the first compensation transistor 660 is electrically connected to the output of the voltage buffer 100. The drain terminal 660d of the first compensation transistor 660 is further electrically connected to a first terminal of a load capacitor 104, the second terminal of the load capacitor 104 being electrically connected to electrical ground.

The charge compensation circuit 460 of FIG. 6B may compensate for a spike in charge at the output of the voltage buffer 100 due to the input signal 348 transitioning from a low voltage state to a high voltage state. As described above, the input signal 348 to the input-output buffer circuit 340 is utilized as the triggering signal 464. While the input signal 348 (e.g., triggering signal 464) is in a low voltage sate, the inverse triggering signal 464n is in a high voltage state, and thus the second compensation transistor 662 is enabled. While enabled, the second compensation transistor 662 electrically connects the first terminal of the charge compensation capacitor 664 to electrical ground, thus, the charge compensation capacitor 664 is discharged. When the input signal 348 transitions to a high voltage state, the second compensation transistor 662 is disabled and the first compensation transistor 660 is enabled. In an instance in which the first compensation transistor 660 is enabled, an electrical connection between the output of the voltage buffer 100 and the charge compensation capacitor 664 is established. Thus, additional charge pushed to the output of the voltage buffer 100 may be pulled to the charge compensation capacitor 664, enabling the buffered output 112 of the voltage buffer 100 to quickly resettle at the reference voltage 108. Improvements in the settling time of the low reference voltage 356 in the presence of transient signals enables quicker response time of the voltage-adjusted output signal 350 of the input-output buffer circuit 340 in response to changes in the input signal 348 received at the input-output buffer circuit 340.

The change in charge at the output of the voltage buffer 100 due to the change in the high pre-driver signal 354a may be matched with an equal and opposite change in charge from the charge compensation capacitor 664. This can be done by calculating the required value of the capacitor 664 by equating the product of the voltage change across 664 to its capacitance with the product of the gate-capacitance of the (usually large) transistor 388 of FIG. 6A and the voltage change at the high pre-driver signal 354a.

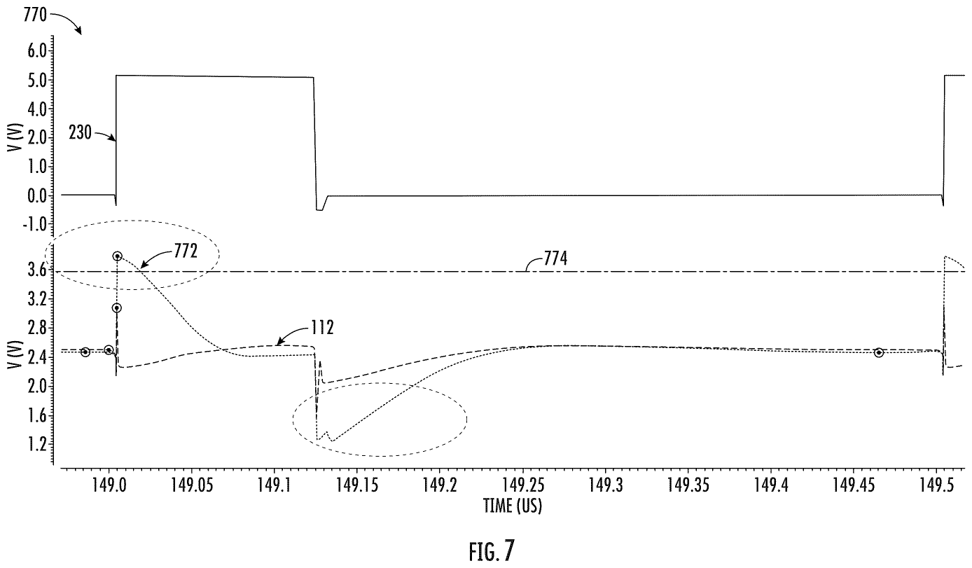

Referring now to FIG. 7, an example graph 770 depicting the output voltage 230 generated by a power stage of the DC-DC converter circuit (e.g., power stage 220 of the DC-DC converter circuit) is depicted.

The graph 770 depicts a buffered output 772. The buffered output 772 corresponds to a buffered output of an example voltage buffer electrically connected to the gate of one of the stacked transistors of the power stage of the DC-DC converter circuit, for example voltage buffer 100 as depicted in FIG. 2A. As depicted in FIG. 2A, the buffered output 772 of the example voltage buffer is not connected to a charge compensation circuit 460. Thus, in response to the transition of the output voltage 230 from a low voltage state to a high voltage state, the buffered output 772 experiences a significant spike. Indeed, the spike of the buffered output 772 exceeds the safe operating limit 774 of the associated transistor. In addition, the buffered output 772 experiences a long delay before settling at the reference voltage.

In contrast, the graph 770 further depicts a buffered output 112. The buffered output 112 corresponds to a buffered output of an example voltage buffer electrically connected to the gate of one of the stacked transistors of the power stage of the DC-DC converter circuit, for example voltage buffer 100 as depicted in FIG. 5. As depicted in FIG. 5, the buffered output 112 of the example voltage buffer is connected to a charge compensation circuit 460. The charge compensation circuit 460 compensates for any charge spike at the output of the voltage buffer in response to the transition of the output voltage 230 from a low voltage state to a high voltage state. Thus, the buffered output 112 experiences a spike significantly smaller than the spike of the buffered output 772. Further, the buffered output 112 resettles to the reference voltage significantly faster than the buffered output 772.

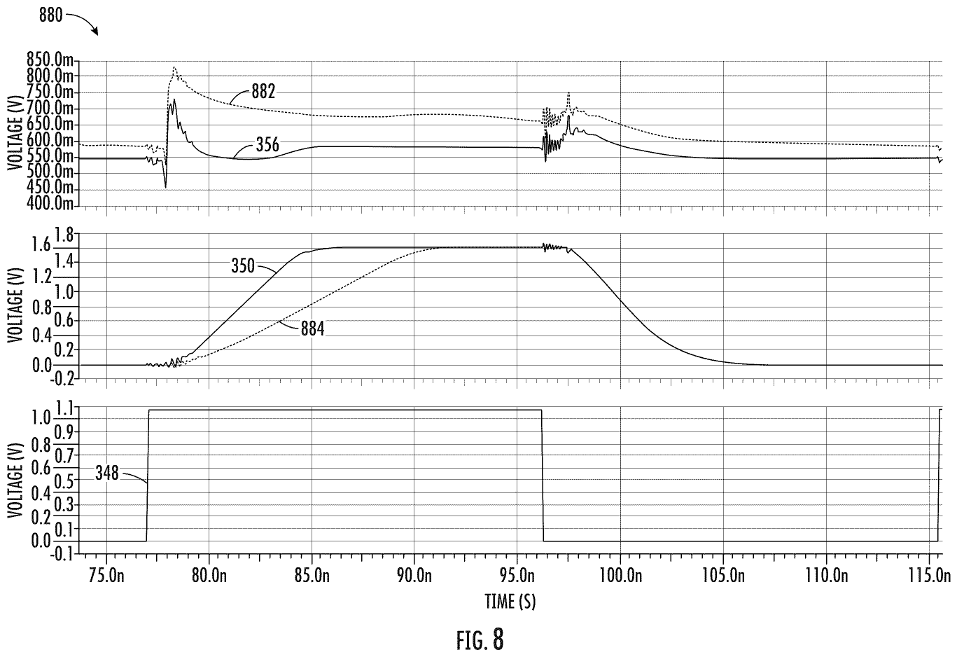

Referring now to FIG. 8, a graph 880 depicting response times on an example input-output buffer circuit (e.g., input-output buffer circuit 340) are provided. The lower portion of graph 880 depicts a change in input signal 348 from a low voltage state to a high voltage state at an example input-output buffer circuit (e.g., input-output buffer circuit 340).

The top portion of graph 880 depicts the low reference voltage generated by an example voltage buffer when connected to a charge compensation circuit (e.g., low reference voltage 356) and without a connection to a charge compensation circuit (e.g., low reference voltage 882). As can be seen from the top portion of the graph 880, the low reference voltage 356 resettles to a stable reference voltage much quicker than the low reference voltage 882. Such improvement in settling is due to the charge compensation circuit (e.g., charge compensation circuit 460 of FIG. 6B) adjusting the charge at the output of the voltage buffer based on the input signal 348.

The middle portion of graph 880 depicts the transition of a voltage-adjusted output signal of the input-output buffer circuit 340 in response to the change of the input signal 348. The voltage-adjusted output signal 350 depicts a voltage-adjusted output signal of an example input-output buffer circuit when a charge compensation circuit is electrically connected to the output of one or more voltage buffers, for example, as depicted in FIG. 6B. The voltage-adjusted output signal 884 depicts a voltage-adjusted output signal of an example input-output buffer circuit when a charge compensation circuit is not utilized. As depicted in the middle portion of graph 880, there is a significant improvement in the response time of the voltage-adjusted output signal output by an input-output buffer circuit when a charge compensation circuit is utilized.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that utilizes a voltage buffer to provide a consistent reference voltage in the presence of signal transients.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A circuit comprising:
a voltage buffer configured to receive an input supply at a voltage buffer input port and generate a buffered output at a voltage buffer output port;
a load circuit configured to generate a load output current signal, wherein a change in the load output current signal alters a charge at the voltage buffer output port; and
a charge compensation circuit, comprising:
a first charge compensation port; and
a second charge compensation port electrically connected to the voltage buffer output port,
wherein the charge compensation circuit detects the change in the load output current signal based on a triggering signal and compensates the charge at the voltage buffer output port.

2. The circuit of claim 1, wherein in an instance in which the change in the load output current signal comprises an increase in voltage, the charge compensation circuit removes charge from the voltage buffer output port.

3. The circuit of claim 1, wherein in an instance in which the change in the load output current signal comprises a decrease in voltage, the charge compensation circuit generates charge at the voltage buffer output port.

4. The circuit of claim 1, wherein the charge compensation circuit further comprises a charge compensation capacitor.

5. The circuit of claim 4, wherein a capacitance of the charge compensation capacitor is based on a parasitic capacitance of the load circuit.

6. The circuit of claim 5, wherein the triggering signal comprises the load output current signal.

7. The circuit of claim 6, wherein the charge compensation circuit further comprises an inverter electrically connected in series with the charge compensation capacitor.

8. The circuit of claim 6, wherein the load output current signal comprises an output of a DC-DC converter circuit.

9. The circuit of claim 5, wherein the triggering signal comprises an input signal to the load circuit.

10. The circuit of claim 9, wherein the charge compensation circuit further comprises:
a first compensation transistor; and
a second compensation transistor.

11. The circuit of claim 10, wherein a first gate of the first compensation transistor is electrically connected to the triggering signal, and a second gate of the second compensation transistor is electrically connected to an inverse triggering signal.

12. The circuit of claim 9, wherein the triggering signal comprises an input to an input-output buffer circuit.

13. A DC-DC converter circuit, comprising:
a power stage comprising a plurality of stacked transistors, including at least a voltage buffer biased transistor configured to receive a buffered output at a gate terminal,
wherein the power stage is configured to generate an output voltage based on a source voltage;
a voltage buffer configured to receive an input supply at a voltage buffer input port and generate the buffered output at a voltage buffer output port;
a load circuit configured to generate a load output current signal, wherein a change in the load output current signal alters a charge at the voltage buffer output port; and
a charge compensation circuit, comprising:
a first charge compensation port configured to receive the output voltage; and
a second charge compensation port electrically connected to the voltage buffer output port,
wherein the charge compensation circuit detects the change in the output voltage and compensates the charge at the voltage buffer output port.

14. The DC-DC converter circuit of claim 13, wherein in an instance in which the output voltage increases in voltage, the charge compensation circuit removes charge from the voltage buffer output port.

15. The DC-DC converter circuit of claim 13, wherein in an instance in which the output voltage decreases in voltage, the charge compensation circuit generates charge at the voltage buffer output port.

16. The DC-DC converter circuit of claim 13, wherein the charge compensation circuit further comprises a charge compensation capacitor, and wherein a capacitance of the charge compensation capacitor is based on a parasitic capacitance of the voltage buffer biased transistor.

17. An input-output buffer circuit, comprising:
an input port configured to receive an input signal;
level-shifter logic circuitry configured to generate a first level-shifted output signal and a second level-shifted output signal;
pre-driver circuitry comprising:
a high pre-driver stage configured to receive the first level-shifted output signal and generate a high pre-driver signal based on a voltage supply and a low reference voltage;
a low pre-driver stage configured to receive the second level-shifted output signal and generate a low pre-driver signal;
a driver stage configured to generate a voltage-adjusted output signal based on the high pre-driver signal, and the low pre-driver signal;
a voltage buffer configured to receive an input supply at a voltage buffer input port and generate the low reference voltage at a voltage buffer output port; and
a charge compensation circuit, comprising:
a first charge compensation port configured to receive the input signal; and
a second charge compensation port electrically connected to the voltage buffer output port,
wherein the charge compensation circuit compensates a charge at the voltage buffer output port based on the input signal.

18. The input-output buffer circuit of claim 17, wherein in an instance in which the input signal increases in voltage, the charge compensation circuit generates charge at the voltage buffer output port.

19. The input-output buffer circuit of claim 17, wherein in an instance in which the input signal decreases in voltage, the charge compensation circuit removes charge from the voltage buffer output port.

20. The input-output buffer circuit of claim 17, wherein the charge compensation circuit further comprises a charge compensation capacitor, and wherein a capacitance of the charge compensation capacitor is based on a parasitic capacitance of a transistor of the high pre-driver stage.
